(19) United States
(12) Patent Application Publication
(10) Pub. No.: US 2023/0371086 A1
(43) Pub. Date: Nov. 16, 2023

(54) COMMUNICATION SYSTEM AND COMMUNICATION METHOD

(71) Applicant: NEC Corporation, Minato-ku, Tokyo (JP)

(72) Inventor: Hideki WATANABE, Tokyo (JP)

(73) Assignee: NEC Corporation, Minato-ku, Tokyo (JP)

(21) Appl. No.: 18/027,193

(22) PCT Filed: Sep. 24, 2021
(86) PCT No.: PCT/JP2021/034948

§ 371 Date: Mar. 20, 2023

(30) Foreign Application Priority Data
Sep. 29, 2020 (JP) 2020-162781

(51) Int. Cl. H04W 76/10; H04W 12/06; H04W 12/40; H04W 8/26

(52) U.S. Cl. CPC H04W 76/10; H04W 12/06; H04W 12/40; H04W 8/26

(57) ABSTRACT

In order to stably operate a 5G system, a communication system according to the present invention comprises: a first device having an authentication means that determines whether to authenticate a terminal in response to a connection request from the terminal and a transferring means that transfers communication data from the terminal when the terminal is authenticated by the authentication means; and a second device having a conversion means that converts the format of and transmits, to an external network, the communication data from the transferring means.

### TECHNICAL FIELD

The present invention relates to a communication system capable of stably operating a fifth generation (5G) system.

### BACKGROUND ART

A 5G system examined in recent years processes communication from a terminal by using a server called a core server, and connects the terminal to an external network. There is a local 5G system that operates such a 5G system within a local area. By applying a local 5G system within an area of a store or a company, a store, a company, or other organizations can connect to an external network by utilizing a 5G network. In recent years, it has been examined that a local 5G system is applied to an evacuation shelter to be provided in a case of a disaster, and a 5G network is utilized from the evacuation shelter.

For example, PTL 1 discloses that, when a disaster occurs, an evacuation shelter wireless local area network (LAN) device is installed in an evacuation shelter, and thereby information transmission/reception within the evacuation shelter is enabled.

### CITATION LIST

### Patent Literature

PTL 1: Japanese Unexamined Patent Application Publication No. 2014-107827

### SUMMARY OF INVENTION

### Technical Problem

When a local 5G system is to be applied to an evacuation shelter and the like, since it is difficult to move a core server used in a general 5G system to an evacuation site in a case of a disaster, it is conceivable that a personal computer (PC) or the like in the evacuation shelter is operated as a provisional core server. However, when a PC performs processing similar to that performed by the core server in the general 5G system, a load on the PC may increase and operation may be unstable.

The present invention is made in view of the above-described problem, and an object of the present invention is to stably operate a provisionally installed 5G system.

### Solution to Problem

A communication system according to the present invention includes:
a first device including
an authentication means for determining, according to a connection request from a terminal, whether to authenticate the terminal, and
a transferring means for transferring, when the authentication means authenticates the terminal, communication data transmitted from the terminal; and
a second device including a conversion means for converting a format of the communication data from the transferring means and transmitting the communication data to an external network.

A communication method according to the present invention includes:
determining, by a first device, whether to authenticate a terminal, according to a connection request from the terminal;
when the terminal is authenticated, transferring, by the first device, communication data transmitted from the terminal; and
converting, by a second device, a format of the transferred communication data and transmitting the communication data to an external network.

### Advantageous Effects of Invention

According to the present invention, stable operation of a provisionally installed 5G system is enabled.

### BRIEF DESCRIPTION OF DRAWINGS

FIG. 1 is a block diagram illustrating a configuration example of a communication system according to a first example embodiment of the present invention.

FIG. 2 is a flowchart illustrating an operation example of the communication system according to the first example embodiment of the present invention.

FIG. 3 is a block diagram illustrating a configuration example of a communication system according to a second example embodiment of the present invention.

FIG. 4 is a flowchart illustrating an operation example of the communication system according to the second example embodiment of the present invention.

### EXAMPLE EMBODIMENT

### First Example Embodiment

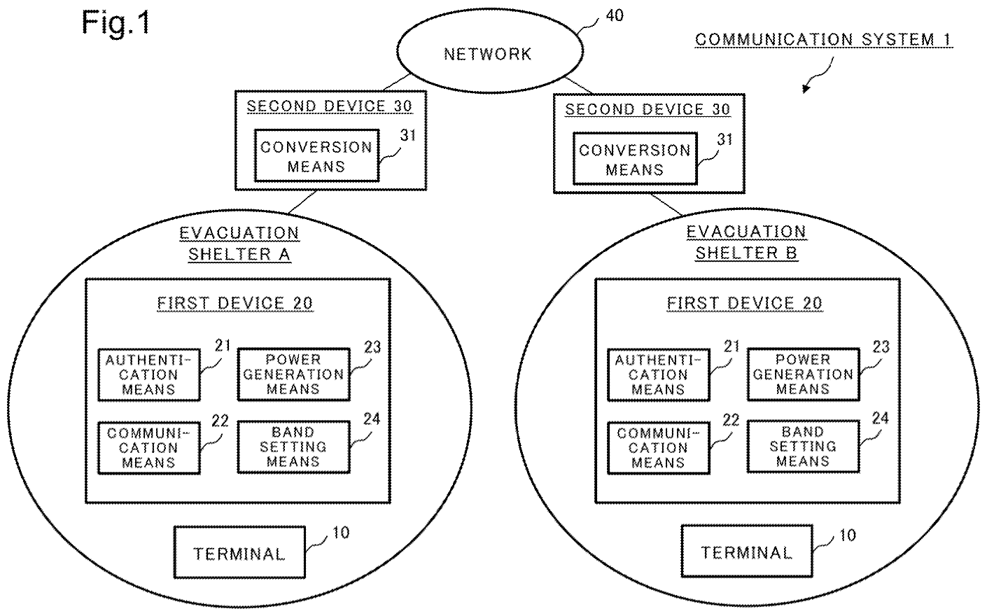

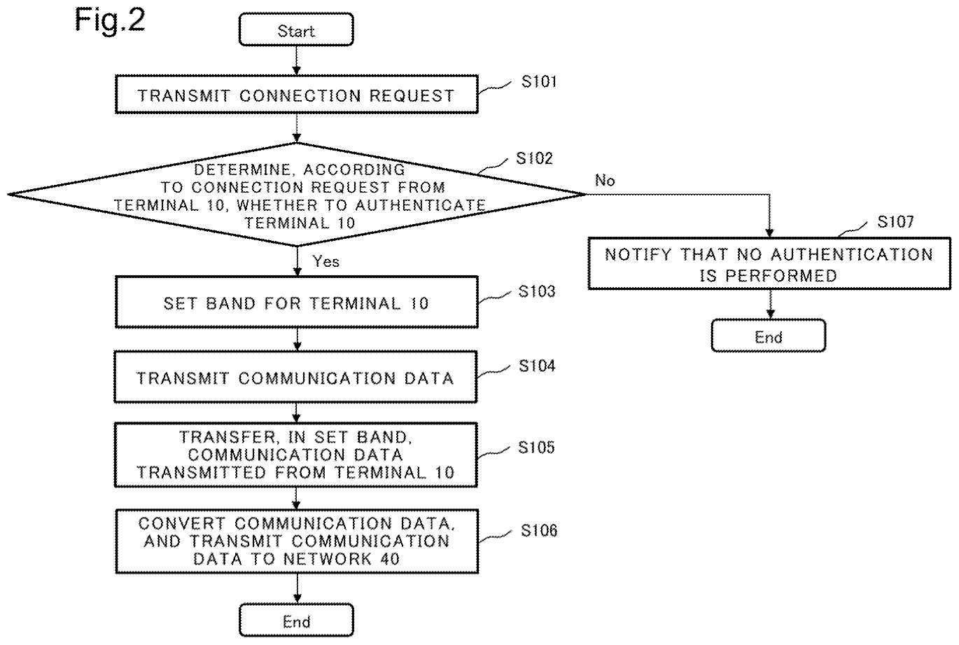

A communication system 1 according to a first example embodiment is described based on FIGS. 1 and 2. FIG. 1 is a block diagram illustrating a configuration example of the communication system 1. FIG. 2 is a flowchart illustrating an operation example of the communication system 1.

A configuration of the communication system 1 is described. The communication system 1 includes two terminals 10, two first devices 20, two second devices 30, and a network 40. The terminal 10, the first device 20, and the second device 30 are provided for each of evacuation shelters A and B.

The terminal 10 transmits a connection request to the first device 20. When the first device that has received the connection request permits the terminal 10 to connect, the terminal 10 can transmit communication data to the network 40, via the first device 20 and the second device 30. At this occasion, the terminal 10 includes, in the communication data, identification information indicating that a transmission source of the communication data is the terminal 10. The identification information is unique information generated from an ID number of a subscriber identity module (SIM) card included in the terminal 10 or a phone number.

The terminal 10 is, for example, a smartphone or the like owned by an evacuee in an evacuation shelter. In this case, the terminal 10 transmits a connection request and communication data, according to an operation by the evacuee. In this case, the communication data includes safety information of the evacuee and a message from the evacuee.

Alternatively, the terminal 10 may also be a camera installed in an evacuation shelter. In this case, the terminal 10 acquires photographic data by capturing surroundings. Further, the terminal 10 transmits communication data including the photographic data to the first device 20.

Further, the terminal 10 may include a global positioning system (GPS). In this case, the terminal 10 acquires positional information indicating a position of the terminal 10, by using the GPS. Further, the terminal 10 transmits communication data including the positional information to the first device 20.

The first device 20 includes, as illustrated in FIG. 1, an authentication means 21, a communication means 22, a power generation means 23, and a band setting means 24. The first device 20 is, for example, a PC.

The authentication means 21 determines, according to a connection request from the terminal 10, whether to authenticate the terminal 10. Specifically, the authentication means 21 acquires the connection request transmitted from the terminal 10, via the communication means 22. For example, when the above-described identification information contained in the connection request coincides with preliminarily stored identification information, the authentication means 21 authenticates the terminal 10. Meanwhile, for example, when the identification information contained in the connection request does not coincide with the preliminarily stored identification information, the authentication means 21 does not authenticate the terminal 10. Further, for example, when the number of authenticated terminals is equal to or less than a predetermined number, the authentication means 21 authenticates the terminal 10. Meanwhile, the authentication means 21 may be revoke authentication of the terminal 10 that does not communicate with the communication means 22 over a predetermined period.

The communication means 22 transfers communication data transmitted from the authenticated terminal 10. Specifically, the communication means 22 transfers communication data transmitted from the terminal 10 authenticated by the authentication means 21 to the second device 30. When acquiring communication data from an unauthenticated terminal, the communication means 22 does not transfer the communication data to the second device 30. When acquiring communication data from an unauthenticated terminal, the communication means 22 may further notify the unauthenticated terminal to transmit a connection request. The communication means 22 corresponds to a transferring means.

The power generation means 23 is capable of generating electric power. The power generation means 23 includes, for example, a solar panel, and is capable of generating electric power by using sunlight and the like. In a normal circumstance, the above-described authentication means 21, the communication means 22, and the band setting means 24 operate on a commercial power supply obtained from wiring installed in an evacuation shelter. Meanwhile, when the commercial power supply cannot be used because the wiring is disconnected due to an earthquake and the like, the authentication means 21, the communication means 22, and the band setting means 24 operates on electric power generated by the power generation means 23.

The band setting means 24 sets a band for the terminal 10 authenticated by the authentication means 21. The communication means 22 transfers communication data transmitted from the terminal 10 to the second device 30, in the band set for the terminal 10.

The band setting means 24 may change a width of a band allocated to each of the terminals 10, according to a change in the number of terminals 10 transmitting communication data to the communication means 22. For example, the band setting means 24 identifies, in a predetermined cycle, the number of the terminals 10 transmitting communication data to the communication means 22, from the number of pieces of identification information contained in communication data in a process of being received by the communication means 22. For example, the communication means 22 reads a header part of communication data at a beginning of a reception process of the communication data, and calculates a cyclic redundancy code (CRC) of the communication data at an end of the reception process. The band setting means 24 determines, for example, communication data of which header part has been read and of which CRC is not calculated yet, to be communication data in a process of being received by the communication means 22.

For example, when the number of the terminals 10 transmitting communication data to the communication means 22 increases, the band setting means 24 narrows a width of a band set for each of the terminals 10. Thereby, a band used by the first device 20 can be prevented from becoming wider when the number of the terminals 10 connecting to the network 40 increases. Meanwhile, for example, when the number of the terminals 10 transmitting communication data to the communication means 22 decreases, the band setting means 24 widens a width of a band set for each of the terminals 10. Thereby, a band that can be used by the first device 20 can be efficiently used when the number of the terminals connecting to the network 40 decreases.

It is assumed that the above-described authentication means 21, the communication means 22, and the band setting means 24 are preliminarily installed on the first device 20. Meanwhile, the authentication means 21, the communication means 22, and the band setting means 24 may be software received by the first device 20 from an external device.

The second device 30 includes a conversion means 31. The conversion means 31 converts a format of communication data from a transferring means 25, and transmits the communication data to the external network 40. Herein, converting a format of data is to converting the format into a format required when the data is transmitted and received within the network 40. For example, the conversion means 31 converts a format of communication data from the transferring means into a format compatible with a data link layer, such as an Ethernet frame.

Specifically, in order to transmit communication data to a communication device in the external network 40, the conversion means 31 assigns a media access control (MAC) address allocated to the communication device to the communication data, as a destination MAC address. At this occasion, the conversion means 31 identifies the terminal 10 from identification information of the terminal 10 contained in communication data from the transferring means 25, and assigns a MAC address that is preliminarily associated with the terminal 10 to the communication data. For example, the conversion means 31 identifies that, from the identification information contained in the communication data, the terminal 10 is a camera installed in the evacuation shelter. In this case, the conversion means 31 assigns, as a destination MAC address, an MAC address of a server owned by a municipality and the like managing the evacuation shelter to the communication data. At this occasion, it is assumed that the conversion means 31 preliminarily has a table indicating correlation between the terminal 10 and the destination MAC address.

At this occasion, the second device 30 connected to the first device in the evacuation shelter A illustrated in FIG. 1 and the second device connected to the first device 20 in the evacuation shelter B illustrated in FIG. 1 may transmit communication data to a same communication device (for example, a server and the like owned by a municipality) in the network 40. Thereby, the communication device can aggregate and manage information from each evacuation shelter.

Next, operation of the communication system 1 is described by using FIG. 2. Note that, at a beginning of the operation, the authentication means 21, communication means 22, and the band setting means 24 operate on a commercial power supply. Further, when the commercial power supply is difficult to be obtained, the authentication means 21, the communication means 22, and the band setting means 24 operate on electric power supplied from the power generation means 23.

The terminal 10 in an evacuation shelter transmits a connection request to the authentication means 21, via the communication means 22 of the first device 20 (S101).

The authentication means 21 determines, according to the connection request from the terminal 10, whether to authenticate the terminal 10 (S102). At this occasion, the authentication means 21 acquires identification information contained in the connection request, and when the identification information is preliminarily registered in the authentication means 21, authenticates the terminal 10. When determining not to authenticate the terminal 10 (No in S102), the authentication means 21 notifies the terminal 10 that the terminal 10 is not to be authenticated (S107).

When the authentication means 21 determines to authenticate the terminal 10 (Yes in S102), the band setting means 24 sets a band for the terminal 10 authenticated by the authentication means 21 (S103). Further, in parallel with the processing in S103, the authentication means 21 notifies the terminal 10 that the terminal 10 is authenticated (S107).

The terminal 10 notified of the authentication transmits communication data acquired by the own device to the communication means 22 (S104).

The communication means 22 transmits, in the set band, the communication data to the second device 30 (S105).

The conversion means 31 converts the communication data from the communication means 22, and transmits the communication data to the network 40 (S106). The conversion means 31 assigns, for example, a MAC address allocated to a communication device being a transmission destination of the communication data to the communication data.

As described above, the communication system 1 includes the first device 20 including the authentication means 21 and the communication means 22, and the second device 30 including the conversion means 31.

Further, the authentication means 21 determines, according to a connection request from the terminal 10, whether to authenticate the terminal 10. Further, when the authentication means 21 authenticates the terminal 10, the communication means 22 (the transferring means) transfers communication data transmitted from the terminal 10. Further, the conversion means 31 converts a format of the communication data from the communication means 22 (the transferring means), and transmits the communication data to an external network.

In a 5G system, it is required that a core server authenticates a terminal, converts a format of communication data from the authenticated terminal into a format compatible with an external network, and transmits the communication data to the external network. At this occasion, when a provisional 5G system is applied to an evacuation shelter and the like, as described in the section of Background Art, it is conceivable that a PC or the like in the evacuation shelter is provisionally operated as a core server. However, when a PC performs processing similar to that performed by a core server in a general 5G system, a load on the PC may increase and operation may be unstable.

Meanwhile, in the communication system 1, the first device 20 performs the processing of authenticating a terminal, and the second device performs the processing of converting communication data. Therefore, a load per device becomes smaller than that in a case in which authentication of a terminal and conversion of communication data are performed by a single device. Thereby, in the communication system 1, stable operation of a provisionally installed 5G system is enabled.

### Second Example Embodiment

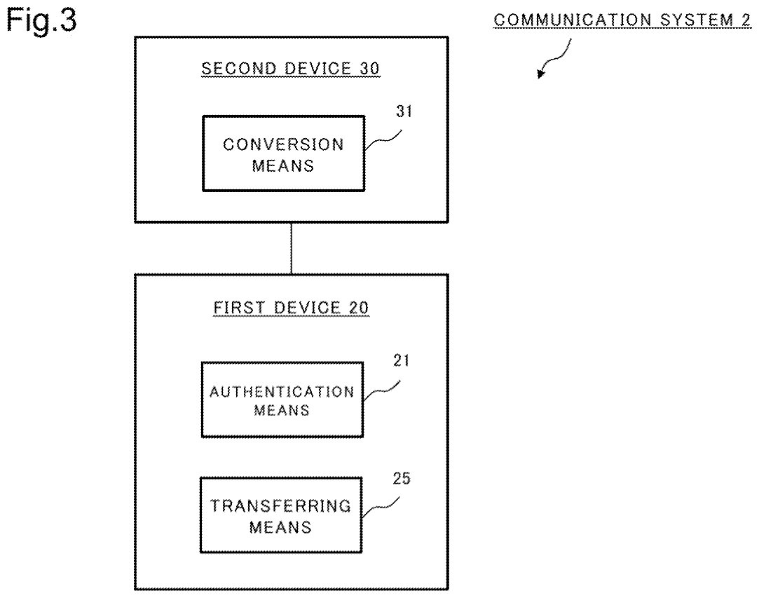

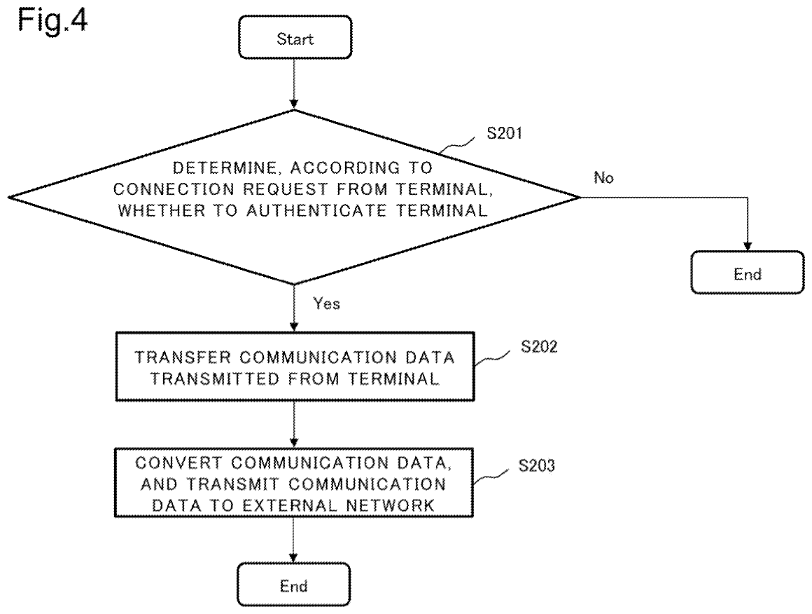

A communication system 2 according to a second example embodiment is described by using FIGS. 3 and 4. As illustrated in FIG. 3, the communication system 2 includes a first device 20 and a second device 30. The first device 20 includes an authentication means 21 and a transferring means 25.

The authentication means 21 determines, according to a connection request from a terminal, whether to authenticate the terminal. The authentication means 21 may have a configuration, a function, and a connection relation that are similar to those of the authentication means 21 according to the first example embodiment.

The transferring means 25 transfers communication data transmitted from the terminal authenticated by the authentication means 21 to the second device 30. The transferring means 25 may have a configuration, a function, and a connection relation that are similar to those of the communication means 22 according to the first example embodiment.

The second device 30 includes a conversion means 31. The conversion means 31 converts a format of communication data from the transferring means 25 and transmits the communication data to an external network. The conversion means 31 may have a configuration, a function, and a connection relation that are similar to those of the conversion means 31 according to the first example embodiment.

Next, operation of the communication system 2 is described by using FIG. 4.

The authentication means 21 determines, according to a connection request from a terminal, whether to authenticate the terminal (S201). When the authentication means 21 does not authenticate the terminal (No in S201), the communication system 2 ends the operation.

When the authentication means 21 authenticates the terminal (Yes in S201), the transferring means 25 transmits communication data transmitted from the terminal to the second device 30 (S202).

The conversion means 31 converts a format of the communication data from the transferring means 25, and transmits the communication data to an external network (S203).

As described above, the communication system 2 includes the first device 20 including the authentication means 21 and the transferring means 25, and the second device 30 including the conversion means 31. Further, the authentication means 21 determines, according to a connection request from a terminal, whether to authenticate the terminal. Further, when the terminal is authenticated, the transferring means 25 transfers communication data transmitted from the terminal. Further, the conversion means 31 converts a format of the communication data from the transferring means 25, and transmits the communication data to an external network.

In a 5G system, it is required that a core server authenticates a terminal, converts a format of communication data from the authenticated terminal into a format compatible with an external network, and transmits the communication data to the external network. At this occasion, when a provisional 5G system is utilized in an evacuation shelter and the like, as described in the section of Background Art, it is conceivable that a PC or the like in the evacuation shelter is provisionally operated as a core server. However, when a PC performs processing similar to that performed by a core server in a general 5G system, a load on the PC may increase and operation may be unstable.

Meanwhile in the communication system 2, the first device 20 performs the processing of authenticating a terminal, and the second device performs the processing of converting communication data. Therefore, a load per device becomes smaller than that in a case in which authentication of a terminal and conversion of communication data are performed by a single device. Thereby, in the communication system 2, stable operation of a provisionally installed 5G system is enabled.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2020-162781, filed on Sep. 29, 2020, the disclosure of which is incorporated herein in its entirety by reference.

### REFERENCE SIGNS LIST

1, 2 Communication system
10 Terminal
20 First device
21 Authentication means
22 Communication means
23 Power generation means
24 Band setting means
25 Transferring means
30 Second device
31 Conversion means
40 Network

What is claimed is:

1. A communication system comprising:
a first device including
an authenticator configured to determine, according to a connection request from a terminal, whether to authenticate the terminal, and
a transmitter configured to transfer, when the authenticator authenticates the terminal, communication data transmitted from the terminal; and
a second device including a converter configured to convert a format of the communication data transferred from the transmitter and transmitting the communication data to an external network.

2. The communication system according to claim 1, wherein
the first device further includes a power generator configured to be capable of generating electric power, and
the authenticator and the transmitter operate by the electric power.

3. The communication system according to claim 1, wherein
the first device further includes a band setter configured to set a band for the authenticated terminal, and
the transmitter transfers the communication data, based on the band.

4. The communication system according to claim 3, wherein the band setter changes a width of the band, according to a change in a number of the terminals authenticated by the authenticator.

5. The communication system according to claim 1, wherein
the first device includes a communicator configured to be capable of communication with an external device, and
the authenticator and the transmitter are software received from the external device.

6. The communication system according to claim 1, wherein the converter converts a format of the communication data by assigning a MAC address allocated to a communication device in the external network to the communication data.

7. The communication system according to claim 1, wherein the terminal outputs, to the transmitter, the communication data containing positional information indicating a position of the terminal.

8. The communication system according to claim 1, wherein the terminal outputs, to the transmitter, the communication data containing photographic data acquired by capturing surroundings of the terminal.

9. A communication method comprising:
determining, by a first device, whether to authenticate a terminal, according to a connection request from the terminal;
when the terminal is authenticated, transferring, by the first device, communication data transmitted from the terminal; and
converting, by a second device, a format of the transferred communication data, and transmitting the communication data to an external network.

10. The communication system according to claim 2, wherein
the first device further includes a band setter configured to set a band for the authenticated terminal, and
the transmitter transfers the communication data, based on the band.

11. The communication system according to claim 10, wherein the band setter changes a width of the band, according to a change in a number of the terminals authenticated by the authenticator.

12. The communication system according to claim 2, wherein
the first device includes a communicator configured to be capable of communication with an external device, and
the authenticator and the transmitter are software received from the external device.

13. The communication system according to claim 3, wherein
the first device includes a communicator configured to be capable of communication with an external device, and
the authenticator and the transmitter are software received from the external device.

14. The communication system according to claim 4, wherein
the first device includes a communicator configured to be capable of communication with an external device, and
the authenticator and the transmitter are software received from the external device.

15. The communication system according to claim 10, wherein
the first device includes a communicator configured to be capable of communication with an external device, and
the authenticator and the transmitter are software received from the external device.

16. The communication system according to claim 11, wherein
the first device includes a communicator configured to be capable of communication with an external device, and
the authenticator and the transmitter are software received from the external device.

17. The communication system according to claim 2, wherein the converter converts a format of the communication data by assigning a MAC address allocated to a communication device in the external network to the communication data.

18. The communication system according to claim 3, wherein the converter converts a format of the communication data by assigning a MAC address allocated to a communication device in the external network to the communication data.

19. The communication system according to claim 4, wherein the converter converts a format of the communication data by assigning a MAC address allocated to a communication device in the external network to the communication data.

20. The communication system according to claim 5, wherein the converter converts a format of the communication data by assigning a MAC address allocated to a communication device in the external network to the communication data.
